(19) United States
(12) Patent Application Publication
(10) Pub. No.: US 2023/0347512 A1
(43) Pub. Date: Nov. 2, 2023

(54) METHODS FOR OPTIMIZING POLYMER THIN FILM PROCESSING

(71) Applicant: Toyota Research Institute, Inc., Los Altos, CA (US)

(72) Inventor: Ha-Kyung Kwon, Mountain View, CA (US)

(73) Assignees: Toyota Jidosha Kabushiki Kaisha, Toyota-shi (JP); Toyota Research Institute, Inc., Los Altos, CA (US)

(21) Appl. No.: 17/731,866

(22) Filed: Apr. 28, 2022

(51) Int. Cl. B25J 9/16; G05B 13/02

(52) U.S. Cl. CPC B25J 9/1653; G05B 13/0265

(57) ABSTRACT

A system for predicting a drying protocol for drying a film containing a polymer includes a processor, and a memory communicably coupled to the processor. The memory includes and stores machine-readable instructions that, when executed by the processor, cause the processor to analyze a captured image of a film containing the polymer dried per a first drying protocol and including a defect, identify and classify the defect, and predict, based at least in part on the first drying protocol and the classified defect, a second drying protocol different than the first drying protocol for drying another film containing the polymer.

### TECHNICAL FIELD

The present disclosure relates generally to polymer film processing and particularly to polymer thin film processing.

### BACKGROUND

Thin polymer films (also referred to herein simply as “polymer films” or “polymer film”) are important for many surface applications, surface-level characterizations of polymers, as well as bulk characterizations of polymers. Also, the use of a polymer for a surface application and/or a surface level characterization of a known or new polymer typically includes development of one or more drying protocols that provide a dried polymer film free of defects.

Development of a drying protocol for a polymer can be a time and cost intensive process that typically involves varying a number of process parameters during drying of “test” polymer films until a dried polymer film with desired properties is provided. Also, since each of the process parameters may or may not be dependent on one or more of the other process parameters and one or more of the process parameters can be strongly dependent on the specific chemistry of the polymer. Accordingly, multiple iterations are typically required before a successful (desired) drying protocol is developed.

The present disclosure addresses issues related to developing a drying protocol for a polymer film, and other issues related to drying of polymer films.

### SUMMARY

This section provides a general summary of the disclosure, and is not a comprehensive disclosure of its full scope or all of its features.

In one form of the present disclosure, a system includes a processor, and a memory communicably coupled to the processor and storing machine-readable instructions that, when executed by the processor, cause the processor to analyze a captured image of a film comprising a polymer and dried per a first drying protocol and having a drying defect, identify and classify the drying defect, and predict, based at least in part on the first drying protocol and the classified defect, a second drying protocol different than the first drying protocol for drying another film of the polymer.

In another form of the present disclosure, a system includes a robotic system configured to form and dry a polymer liquid layer on a surface, a processor in communication with the robotic system, and a memory communicably coupled to the processor. The memory includes and stores machine-readable instructions that, when executed by the processor, cause the processor to execute the following steps: a) instruct the robotic system to form a film of a polymer comprising the polymer and a solvent; b) instruct the robotic system to dry the film per a first drying protocol and form a dried film of the polymer; c) capture and analyze an image of the dried film; d) identify and classify, when present, a drying defect in the dried film; e) predict, based at least in part on the classified defect, a defect formation mechanism for the classified defect; f) predict, based at least in part on at least one of the classified defect and the defect formation mechanism, a second drying protocol for drying another film of the polymer; and g) instruct the robotic system to form and dry the another film per the second drying protocol and form another dried film of the polymer.

In still another form of the present disclosure, a method includes analyzing an image of a film of a polymer dried per a first drying protocol and determining a defect in the dried film, and predicting via machine learning a second drying protocol different than the first drying protocol.

Further areas of applicability and various methods of enhancing the above technology will become apparent from the description provided herein. The description and specific examples in this summary are intended for purposes of illustration only and are not intended to limit the scope of the present disclosure.

### BRIEF DESCRIPTION OF THE DRAWINGS

The present teachings will become more fully understood from the detailed description and the accompanying drawings, wherein:

FIG. 1A illustrates a side view of a polymer film dried per a first drying protocol;

FIG. 1B is a top view of the polymer film in FIG. 1A;

FIG. 1C illustrates a top view of the polymer film in FIG. 1A dried per a second drying protocol;

FIG. 1D illustrates a top view of the polymer film in FIG. 1A dried per a third drying protocol;

FIG. 1E illustrates a top view of the polymer film in FIG. 1A dried per a fourth drying protocol;

FIG. 2 illustrates an example of a machine learning system for predicting a drying protocol according to the teachings of the present disclosure;

FIG. 3 shows a flow chart for a machine learning method for predicting a drying protocol using the system illustrated in FIG. 2;

FIG. 4 shows a flow chart for another machine learning method for predicting a drying protocol using the system illustrated in FIG. 2;

FIG. 5 shows a flow chart for still another machine learning method for predicting a drying protocol using the system illustrated in FIG. 2;

FIG. 6 shows a flow chart for yet still another machine learning method for predicting a drying protocol using the system illustrated in FIG. 2;

FIG. 7 shows a flow chart for developing a drying protocol for drying a polymer film according to the teachings of the present disclosure; and

FIG. 8 shows a flow chart for developing a drying protocol for drying a polymer film according to the teachings of the present disclosure.

### DETAILED DESCRIPTION

The present disclosure provides a machine learning (ML) system and a ML method for predicting a drying protocol for a polymer film. The polymer film is formed by mixing a polymer with a solvent to form a polymer solution, applying the polymer solution to a surface to form a thin film, and drying the polymer solution per a drying protocol to form a dried polymer film. The drying protocol includes a set of drying process parameters (also referred to herein simply as “process parameters”) such as the solvent in the polymer solution, the solvent concentration in the polymer solution, a drying temperature, a drying time, and a gas flow rate for gas (e.g., air) blowing over and/or onto the polymer solution applied to the surface, among others. The ML system and ML method can learn one or more drying protocols using a training dataset and predict a drying protocol for a new polymer. In some variations, the training dataset includes tens, hundreds, or thousands of captured images of dried polymer films with one or more defects, and for which the polymers and drying protocols are known. In the alternative, or in addition to, the training dataset includes the results of analysis of tens, hundreds, or thousands of captured images of dried polymer films with one or more defects, and for which the polymers and drying protocols are known.

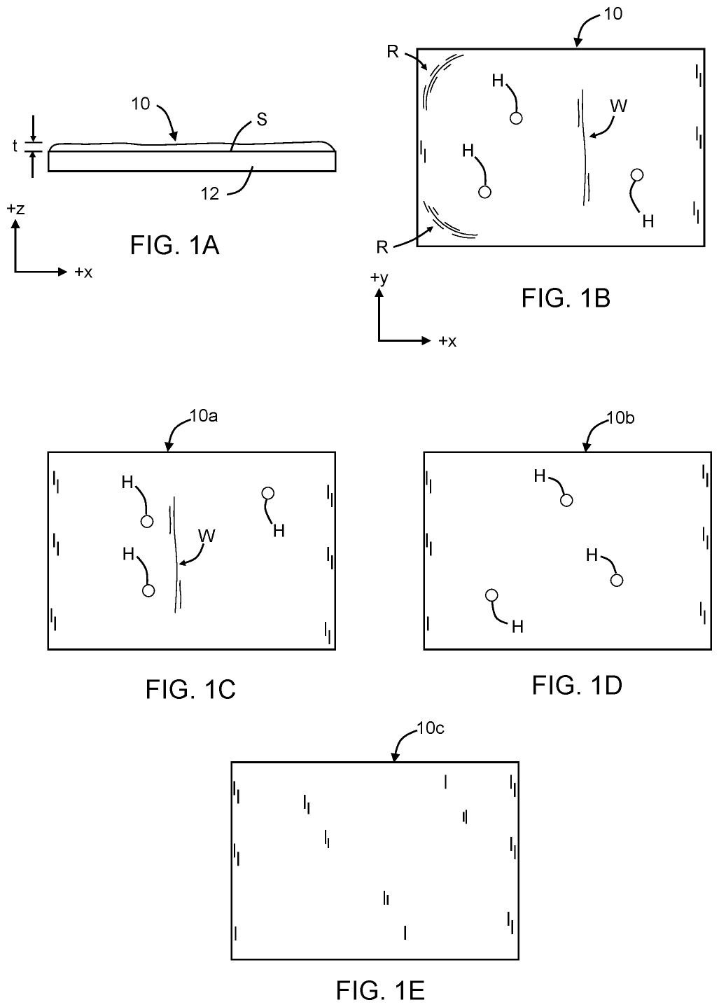

Referring to FIGS. 1A-1E, illustrative examples of polymer films formed from a new polymer and dried using different drying protocols are shown. As used herein, the term “new polymer” refers to a polymer that does not have a known desired drying protocol. That is, the new polymer can be a known polymer for which a desired drying protocol has not yet been developed or a polymer that has been synthesized and is generally not known to the scientific and/or industrial community, and for which a desired drying protocol has not yet been developed. As used herein, the phrase “desired drying protocol” refers to a drying protocol that results in a dried polymer film that is free of defects such as holes in the dried polymer film, rings (ridges) in the dried polymer film, and/or wrinkles in the dried polymer film, among others.

FIGS. 1A and 1B show a side view and top view, respectively, of a dried polymer film 10 that has been formed on a surface ‘S’ of a substrate 12 by drying a polymer solution that has been applied to the surface S using a first protocol. The polymer solution (not shown) includes a new polymer from which the dried polymer film 10 is formed and a solvent. The dried polymer film 10 has a thickness ‘t’, a thickness profile along the x-direction shown in FIG. 1A, and one or more defects as shown in FIG. 1B. For example purposes only, the dried polymer film 10 shown in FIG. 1B includes at least one hole ‘H’, a ring ‘R’ along an outer perimeter of the dried polymer film 10, and a wrinkle ‘W’. It should be understood that for the purposes of the present disclosure, such defects are undesirable and other defects can be present.

Referring to FIG. 1C, the dried polymer film 10a has been formed on the surface S by applying a polymer solution containing the same polymer as in FIGS. 1A-1B, but dried using a second drying protocol that is different than the first drying protocol. That is, the second drying protocol includes at least one change to a process parameter compared to the process parameters of the first drying protocol. In addition, FIG. 1C shows the dried polymer film 10a does not have or exhibit the ring R defect, but still has the hole H and wrinkle W defects. Accordingly, it should be understood that using the second protocol to dry the polymer solution applied to the surface S results in a reduction of defects in the dried polymer film 10a.

Referring to FIG. 1D, the dried polymer film 10b has been formed on the surface S by applying a polymer solution containing the same polymer as in FIGS. 1A-1C, but dried using a third drying protocol that is different than the first and second drying protocols. That is, the third drying protocol includes a change in at least one process parameter compared to the process parameters in the first and second drying protocols. In addition, FIG. 1D shows the dried polymer film 10b does not have or exhibit the ring R defect or the wrinkle W defect, but still has the hole H defect. Accordingly, it should be understood that using the third protocol to dry the polymer solution applied to the surface S resulted in a further reduction of defects in the dried polymer film 10b.

And referring to FIG. 1E, the dried polymer film 10c has been formed on the surface S by applying a polymer solution containing the same polymer as in FIGS. 1A-1D, but dried using a fourth drying protocol that is different than the first, second, and third drying protocols. That is, the fourth drying protocol includes a change in at least one process parameter compared to the process parameters in the first, second and third drying protocols. In addition, FIG. 1E shows the dried polymer film 10c does not have or exhibit the ring R defect, the wrinkle W defect, or the hole H defect. Accordingly, it should be understood that using the fourth protocol to dry the polymer solution applied to the surface S resulted in a dried polymer film 10c without the defects R, W, and H. That is, a desired drying protocol has been developed. And while only four iterations of forming the dried polymer film 10c are illustrated in FIGS. 1A-1E, it should be understood that development of a desired drying protocol can include tens or hundreds of iterations. And it should also be understood that for some new polymers, development of a desired drying protocol is not achieved due to constraints such as time and cost, among others.

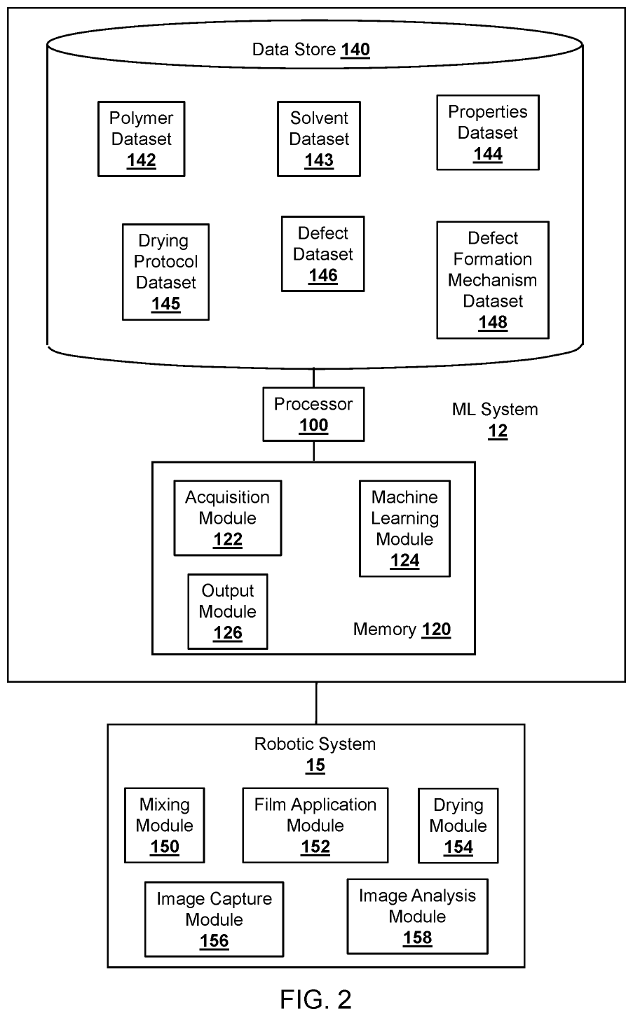

Referring now to FIG. 2, a ML system 12 for predicting a drying protocol for a new polymer film is illustrated. The ML system 12 is shown including at least one processor (referred to herein simply as “processor”) 100, and a memory 120 and a data store 140 communicably coupled to the processor 100. It should be understood that the processor 100 can be part of the ML system 12, or in the alternative, the ML system 12 can access the processor 100 through a data bus or another communication path.

The memory 120 is configured to store an acquisition module 122, a ML module 124, and an output module 126. The memory 120 is a random-access memory (RAM), read-only memory (ROM), a hard-disk drive, a flash memory, or other suitable memory for storing the acquisition module 122, ML module 124, and output module 126. Also, the acquisition module 122, ML module 124, and output module 126 are, for example, computer-readable instructions that when executed by the processor 100 cause the processor to perform the various functions disclosed herein.

In some variations the data store 140 is a database, e.g., an electronic data structure stored in the memory 120 or another data store. Also, in at least one variation the data store 140 in the form of a database is configured with routines that can be executed by the processor 100 for analyzing stored data, providing stored data, organizing stored data, and the like. Accordingly, in some variations the data store 140 stores data used by the acquisition module 122, the ML module 124, and/or the output module 126. For example, and as shown in FIG. 2, in at least one variation the data store stores a polymer dataset 142, a solvent dataset 143, a properties dataset 144, a drying protocol dataset 145, a defect dataset 146, and a defect formation mechanism dataset 148.

In some variations the polymer dataset 142 includes a listing of a polymers and associated chemistries, chemical structures, and physical properties. In other variations, one or more of the associated chemistries, chemical structures (e.g., chemical structures per SMILES format), and physical properties of at least a subset of the polymers in the polymer dataset 142 are included in the properties dataset 144. Also, it should be understood that the associated chemistries, chemical structures, and physical properties can be properly tagged and/or associated with the listing of polymers in the polymer dataset 142. Non-limiting examples of polymers in the polymer dataset 142 can include thermoplastic polymers, thermosetting polymers, elastomers, copolymers (block, alternating, gradient), and blends of polymers.

Non-limiting examples of physical properties of the polymers in the polymer dataset 142 and/or the properties dataset 144 include glass transition temperature of a polymer of the polymer film, a Flory-Huggins parameter of the polymer of the polymer film, a density of the polymer of the polymer film, a molecular weight of the polymer of the polymer film, a molar volume of the polymer of the polymer film, a degree of polymerization of the polymer of the polymer film, a crystallinity of the polymer of the polymer film, and a specific gravity of the polymer of the polymer film, among others.

In at least one variation the polymer dataset 142 includes a training dataset that includes training data, sometimes referred to as “ground-truth data” in the form of training polymers for which properties in the property dataset 144, drying protocol(s) in the drying protocol dataset 145, defect(s) in the defect dataset 146, and/or defect formation mechanism(s) in the defect formation mechanism dataset 148 is/are known and tagged to the training polymers. That is, the training polymers have been mixed with solvent(s), applied to a surface, and dried per a drying protocol to form dried polymer films, and known properties of the training polymers, drying protocol(s) of the dried polymer films, defect(s) in the dried polymer films and/or defect formation mechanism(s) for defects in the dried polymer films are tagged to the training polymers.

In some variations the solvent dataset 143 includes a listing of solvents and associated chemistries, chemical structures, and physical properties. In other variations, one or more of the associated chemistries, chemical structures, and physical properties of at least a subset of the solvents in the solvent dataset 143 are included in the properties dataset 144.

Non-limiting examples of physical properties of the solvents in the solvent dataset 143 and/or properties dataset 144 include density, boiling point, melting point, flash point, freezing point, viscosity, ultraviolet (UV) cutoff, refractive index, dielectric constant, miscibility, molecular weight, polarity index, surface tension, and vapor pressure, among others.

In some variations, the drying protocol dataset 145 includes at least one drying protocol for at least a subset of the polymers in the polymer dataset 142. For example, for known polymers in the polymer dataset 142, the drying protocol dataset 145 can include a solvent and a concentration of the solvent hat should be or was mixed with a given polymer listed in the polymer dataset 142 in order to form a polymer solution that is or was applied to a surface of a substrate, a temperature for which the polymer solution should be or was held during drying (i.e., a drying temperature), a time for which the polymer solution should be or was actively dried (i.e., a drying time), and/or a gas flow rate for which a gas should be or was blown over or onto the polymer solution.

In some variations, the defect dataset 146 includes one or more defects known to exist in dried polymer films and/or to form during drying of polymer films. In at least one variation, one or more of the defects in the defect dataset 146 are tagged with one or more polymers in the polymer dataset 142, one or more drying protocols in the drying protocol dataset 145, and/or one or more defect formation mechanisms in the defect formation mechanism dataset 148. For example, defects that formed during drying of a first polymer solution using a first drying protocol can be included in the defect dataset 146 and be tagged to the polymer in the first polymer solution, the first polymer solution, and/or the first drying protocol. Non-limiting examples of defects in the defect dataset 146 include holes, rings, wrinkles, non-uniform thickness, bubbles, pinholes, islands, and terraces, among others.

In some variations, the defect formation mechanism dataset 148 includes one or more defect formation mechanisms known to result in defects that exist in dried polymer films and/or form during drying of polymer thin films. In at least one variation, one or more of the defect formation mechanisms in the defect formation mechanism dataset 148 are tagged with one or more polymers in the polymer dataset 142, a combination of a polymer in the polymer dataset 142 and a solvent in the solvent dataset 143, one or more drying protocols in the drying protocol dataset 145, and/or one or more defects in the defect dataset 146. For example, defect formation mechanisms for defects that formed during drying of a first polymer solution using a first drying protocol can be included in the defect formation mechanism dataset 148 and can be tagged to the polymer in the first polymer solution and/or the first drying protocol. Non-limiting examples of defect formation mechanisms in the defect formation mechanism dataset 148 include solvent evaporation rate (too high or too low), solubility of a polymer in a solvent (too high or too low), polymer not miscible in a solvent, drying temperature (too high or too low), drying time (too short or too long), gas flow rate (too high or too low), and combinations thereof.

The acquisition module 122 can include instructions that function to control the processor 100 to select a training data set from the polymer dataset 142. For example, in some variations the acquisition module 122 includes instructions that function to control the processor 100 to select a training dataset that includes a subset of polymers that each have a tagged solvent, property(ies), defect(s) and/or defect formation mechanism(s) in the solvent dataset 143, properties dataset 144, defect dataset 146 and/or defect formation mechanism dataset 148, respectively. Also, the ML module 124 can include instructions that function to control the processor 100 to impute the training data set into a ML model (algorithm) and train the ML model to learn one or more drying protocols based at least in part on the tagged solvent, properties, defect and/or defect formation mechanism in the solvent dataset 143, properties dataset 144, defect dataset 146 and/or defect formation mechanism dataset 148, respectively, and one or more drying protocols in the drying protocol dataset 145 that are tagged to the subset of polymers.

The ML module 124 can also impute a polymer from the polymer dataset 142 that is not in the training dataset, a solvent from the solvent dataset 143, a property(ies) of the polymer in the properties dataset 144, a defect(s) from the defect dataset 146, and/or a defect formation mechanism(s) from the defect formation mechanism dataset 148 into the ML model. In addition, the ML module 124 can include instructions that function to instruct the ML model (algorithm) to predict one or more drying protocols for the polymer, based at least in part on the solvent from the solvent dataset 143, the property(ies) of the polymer in the properties dataset 144, the defect(s) from the defect dataset 146, and/or the defect formation mechanism(s) from the defect formation mechanism dataset 148.

The output module 126 includes instructions that function to control the processor 100 to output or provide one or more predicted drying protocols to a user and/or store the one or more predicted drying protocols in the drying protocol dataset 145.

In some variations, acquisition module 122, the ML module 124, and the output module 126 can include instructions that function to control the processor 100 to perform or execute one or more of the following: select a training dataset from the polymer dataset 142; select one or more tagged solvents from the solvent dataset 143; selected one or more tagged properties from the properties dataset 144; select one or more drying protocols from the drying protocol dataset 145; select one or more defects from the defect dataset 146; select one or more defect formation mechanisms from the defect formation mechanism dataset 148; train a ML model to learn one or more drying protocols based at least in part on the selected features noted above; and output one or more learned drying protocols for one or more polymers in the training dataset.

The acquisition module 122, the ML module 124, and the output module 126 can also include instructions that function to control the processor 100 to perform or execute one or more of the following: predict one or more drying protocols as a function of one or more polymers in the polymer dataset 142 that is/are not in the training dataset; and output one or more predicted drying protocols for the one or more polymers in the polymer dataset 142 and not in the training dataset.

Non-limiting examples of the ML model include supervised ML models such as nearest neighbor models, Naïve Bayes models, decision tree models, linear regression models, support vector machine (SVM) models, and neural network models, among others. In at least one variation, the ML model is a Gaussian Process regression model. Also, training of the ML model provides a prediction of an optimized material composition with respect to a predefined material property to within a desired value (i.e., less than or equal to a desired value) of a cost function.

Still referring to FIG. 2, in some variations of the present disclosure, the ML system 12 is in communication with a robotic system 15 that includes a mixing module 150, a film application module 152, a drying module 154, an image capture module 156, and an image analysis model 158. The mixing module 150 is configured to receive and execute instructions, e.g., instructions from a user input module (not shown) or the ML system 12, to mix a predefined amount of a predefined polymer with a predefined amount of a predefined solvent to form a polymer solution. The film application module 152 is configured to receive and execute instructions, e.g., instructions from a user input module (not shown) or the ML system 12, to apply a polymer solution on a surface and form a thin film of the polymer solution. Non limiting examples or methods of applying a the polymer solution to a surface include knife coating, panning, spraying, electrostatic sparing, dip coating, spinning, and electro spinning, among others.

The drying module 154 is configured to receive and execute instructions, e.g., instructions from a user input module (not shown) or the ML system 12, to dry the thin film of the polymer solution using a predefined drying protocol such that a dried polymer film is formed. The image capture module 156 is configured to receive and execute instructions, e.g., instructions from a user input module (not shown) or the ML system 12, to capture an image (e.g., a surface or top view image) of the dried polymer film. And the image analysis model 158 is configured to receive and execute instructions, e.g., instructions from a user input module (not shown) or the ML system 12, to analyze a captured image of a dried polymer and identify, and optionally classify, one or more defects in the captured image. In some variations, the image analysis model 158 is configured to transmit information on one or more defects identified, and optionally classified, to a user and/or the ML system 12.

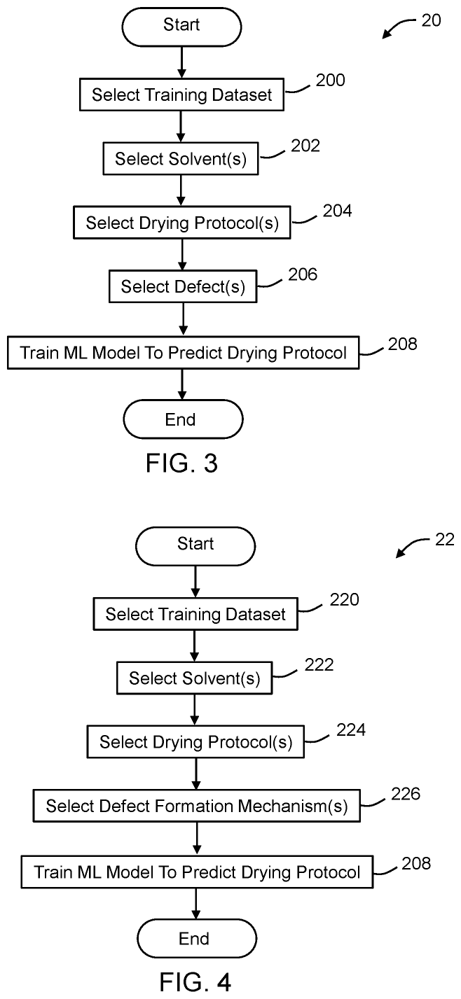

Referring to FIG. 3, a method 20 of training a ML model to learn a drying protocol using the ML system 12 in FIG. 2 includes selecting a training dataset from the polymer dataset 142 at 200 (optionally including tagged properties in the property dataset 144), selecting one or more tagged solvents from the solvent dataset 143 at 202, selecting one or more tagged drying protocols from the drying protocol dataset 145 at 204, selecting one or more tagged defects from the defect dataset 146 at 206, and training the ML model to learn one or more drying protocols at 208. In some variations, the learned drying protocol(s) is/are subsequently stored in the drying protocol dataset 145. In addition, it should be understood that method 20 trains the ML model to learn one or more drying protocols without using one or more defect formation mechanisms from the defect formation mechanism dataset 148.

Referring to FIG. 4, another method 22 of training a ML model to learn a drying protocol using the ML system 12 in FIG. 2 includes selecting a training dataset from the polymer dataset 142 at 220 (optionally including tagged properties in the property dataset 144), selecting one or more tagged solvents from the solvent dataset 143 at 222, selecting one or more tagged drying protocols from the drying protocol dataset 145 at 224, selecting one or more tagged defect formation mechanisms from the defect formation mechanism dataset 148 at 226, and training the ML model to learn one or more drying protocols at 228. In some variations, the learned drying protocol(s) is/are subsequently stored in the drying protocol dataset 145. In addition, it should be understood that method 22 trains the ML model to learn one or more drying protocols without using one or more defects from the defect dataset 146.

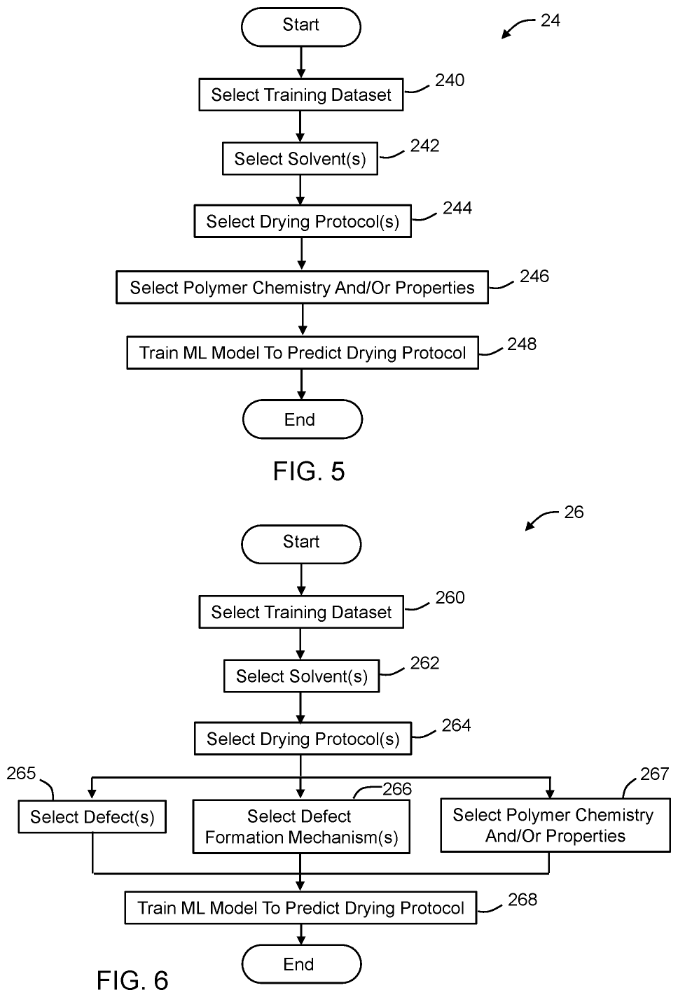

Referring to FIG. 5, still another method 24 of training a ML model to learn a drying protocol using the ML system 12 in FIG. 2 includes selecting a training dataset from the polymer dataset 142 at 240, selecting one or more tagged solvents from the solvent dataset 143 at 242, selecting one or more tagged drying protocols from the drying protocol dataset 145 at 224, selecting one or more tagged properties from the properties dataset 144 at 246, and training the ML model to learn one or more drying protocols at 248. In some variations, the learned drying protocol(s) is/are subsequently stored in the drying protocol dataset 145. In addition, it should be understood that method 24 trains the ML model to learn one or more drying protocols without using one or more defects from the defect dataset 146 and one or more defect formation mechanisms from the defect formation mechanism dataset 148.

Referring to FIG. 6, still yet another method 26 of learning a drying protocol using the ML system 12 in FIG. 2 includes selecting a training dataset from the polymer dataset 142 at 260, selecting one or more tagged solvents from the solvent dataset 143 at 262, and selecting one or more tagged drying protocols from the drying protocol dataset 145 at 262. In addition, the method 26 includes at least two of: selecting one or more tagged defects from the defect dataset 146 at 265, selecting one or more tagged defect formation mechanisms from the defect formation mechanism dataset 148 at 266; and selecting one or more tagged properties from the properties dataset 144 at 267. The method 26 then proceeds to training the ML model to learn one or more drying protocols at 268. In some variations, the predicted drying protocol(s) is/are subsequently stored in the drying protocol dataset 145. In addition, it should be understood that method 26 trains the ML model to learn one or more drying protocols using a combination of one or more defects from the defect dataset 146, one or more defect formation mechanisms from the defect formation mechanism dataset 148, and/or one or more properties from the properties dataset 144.

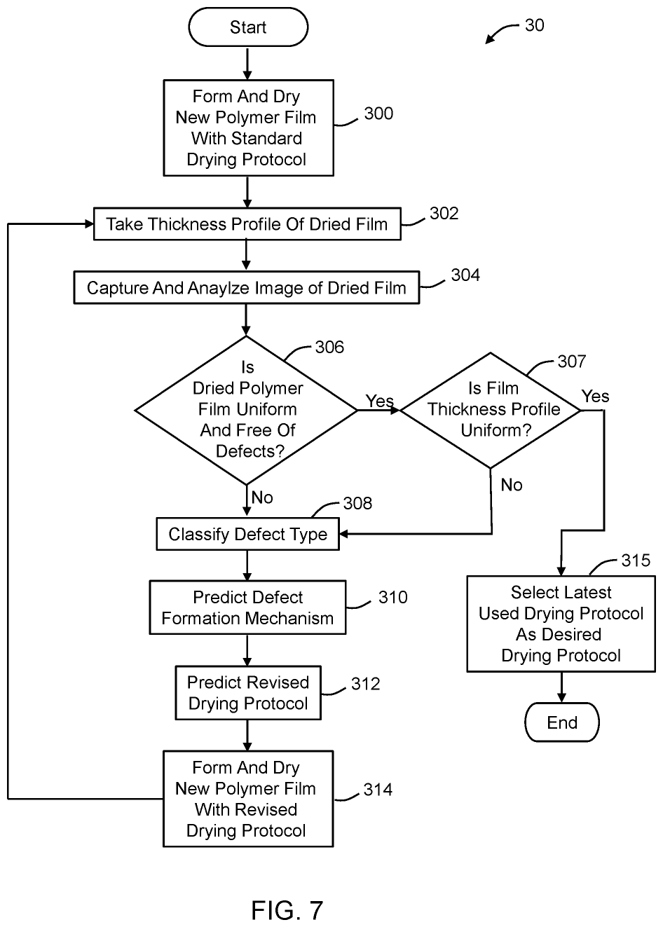

Referring to FIG. 7, a method 30 for determining a drying protocol for a new polymer using the ML system 12 in FIG. 2 is shown. The method 30 includes forming and drying a new polymer film (i.e., a polymer film formed from a polymer solution containing a new polymer and a solvent) using a standard or first drying protocol at 300, taking or measuring a thickness profile of the dried polymer film at 302, and capturing and analyzing an image of the dried polymer film at 304. In some variations, analysis of the image of the dried polymer film includes identifying whether or not one or more defects are present in the image of the dried polymer film. At 306, the method 30 determines whether or not the dried polymer film is free of defects based at least in part on the analyzed image of the dried polymer film. If the dried polymer film is not free of defects, the method proceeds to 308 where the method 30 classifies the defect or defects. In the alternative, if the dried polymer film is determined to be free of defects at 306, the method 30 proceeds to 307 where the method 30 determines or analyzes whether or not the thickness profile of the dried polymer film is uniform to within a predefined tolerance, e.g., within 10 micrometers (μm), within 20 μm, or within 30 μm. If the thickness profile of the dried polymer film is uniform to within the predefined tolerance, the method 30 selects the standard drying protocol as the desired drying protocol for the new polymer at 315. In the alternative, i.e., the thickness profile of the dried polymer film is not uniform to within the predefined tolerance, the method 30 proceeds to 308 where the method 30 classifies the non-uniform thickness profile of the dried polymer film as a defect.

After classifying the defect(s) of the dried polymer film at 308, the method 30 predicts one or more defect formation mechanisms at 310 and predicts a revised or second drying protocol at 312 before forming and drying another polymer film (with the new polymer) using the revised drying protocol at 314. The method 30 then proceeds back through steps 302-314 until a desired drying protocol is predicted and selected by the ML system 12 at 315. It should be understood that the method 30 can be implemented in part or in total using a robotic system, e.g., the robotic system 14 described above.

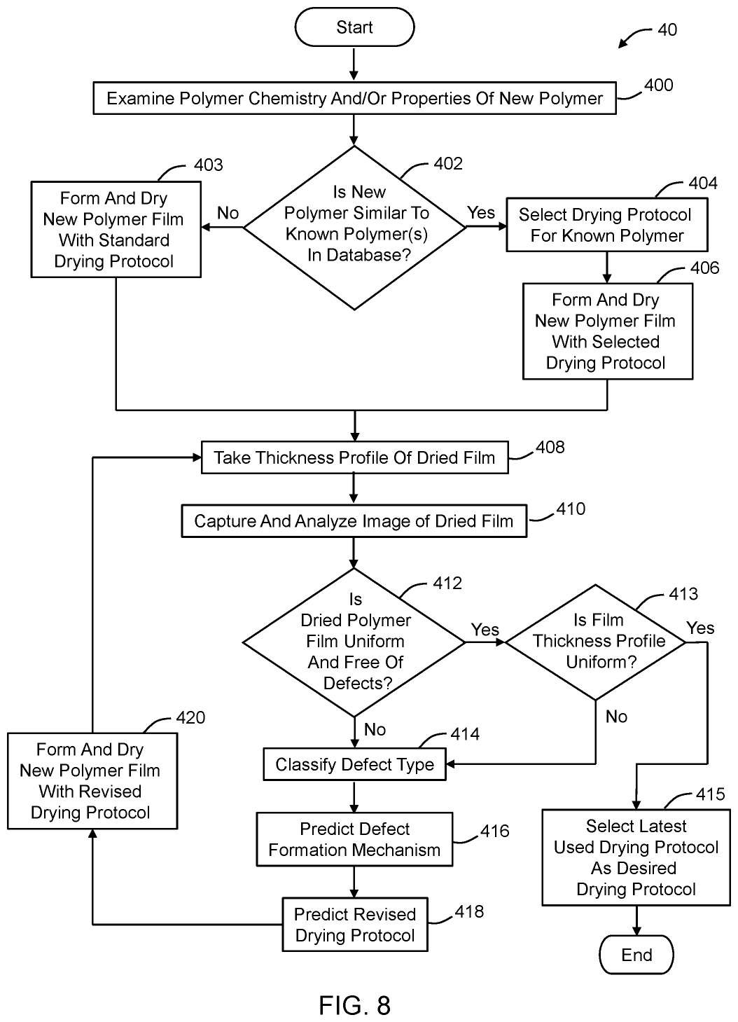

Referring now to FIG. 8, another method 40 for determining a drying protocol for a new polymer using the ML system 12 in FIG. 2 is shown. The method 40 includes examining the polymer chemistry (including the chemical structure) and/or one or more physical properties of a new polymer at 400 and determining whether or not the polymer chemistry and/or one or more of the physical properties of the new polymer is/are similar to the polymer chemistry and/or one or more of the physical properties of a known polymer in the polymer dataset 142 at 402. If the polymer chemistry and/or one or more physical properties of the new polymer is not similar to the polymer chemistry and/or one or more of the physical properties of a known polymer in the polymer dataset 142, the method proceeds to 403 where a new polymer film is formed and dried using a standard or first drying protocol stored in the drying protocol dataset 145. In the alternative, i.e., the polymer chemistry and/or one or more physical properties of the new polymer is similar to the polymer chemistry and/or one or more of the physical properties of a known polymer in the polymer dataset 142, the method 40 proceeds to 404 where the drying protocol in the drying protocol dataset 145 for the known polymer in the polymer dataset 142 is selected and used to form and dry the new polymer film at 406.

The method 40 then proceeds to taking or measuring a thickness profile of the dried polymer film at 408, and capturing and analyzing an image of the dried polymer film at 410. In some variations, analysis of the image of the dried polymer film includes identifying whether or not one or more defects are present in the image of the dried polymer film. At 412, the method 40 determines whether or not the dried polymer film is free of defects based at least in part on the analyzed image of the dried polymer film. If the dried polymer film is not free of defects, the method 40 proceeds to 414 where the method 40 classifies the defect or defects in the captured image. In the alternative, if the dried polymer film is determined to be free of defects at 412, the method 40 proceeds to 413 where the method 40 determines whether or not the thickness profile of the dried polymer film is uniform to within a predefined tolerance. If the thickness profile of the dried polymer film is uniform to within the predefined tolerance, the method 40 selects the drying protocol selected at 403 or 404 as the desired drying protocol for the new polymer at 415. In the alternative, if the thickness profile of the dried polymer film is not uniform to within the predefined tolerance, the method 40 proceeds to 414 where the method 40 classifies the non-uniform thickness profile of the dried polymer film as a defect.

After classifying the defect(s) of the dried polymer film at 414, the method 40 predicts one or more defect formation mechanisms at 416 and predicts a revised or second drying protocol at 418 before forming and drying another polymer film with the new polymer and using the revised drying protocol at 420. The method 40 then proceeds back through steps 408-420 until a desired drying protocol is predicted and selected by the ML system 12 at 415. It should be understood that the method 40 can be implemented in part or in total using a robotic system, e.g., the robotic system 14 described above.

The preceding description is merely illustrative in nature and is in no way intended to limit the disclosure, its application, or uses. Work of the presently named inventors, to the extent it may be described in the background section, as well as aspects of the description that may not otherwise qualify as prior art at the time of filing, are neither expressly nor impliedly admitted as prior art against the present technology.

As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure, and are not intended to limit the disclosure of the technology or any aspect thereof. The recitation of multiple variations or forms having stated features is not intended to exclude other variations or forms having additional features, or other variations or forms incorporating different combinations of the stated features.

As used herein the term “about” when related to numerical values herein refers to known commercial and/or experimental measurement variations or tolerances for the referenced quantity. In some variations, such known commercial and/or experimental measurement tolerances are +/−10% of the measured value, while in other variations such known commercial and/or experimental measurement tolerances are +/−5% of the measured value, while in still other variations such known commercial and/or experimental measurement tolerances are +/−2.5% of the measured value. And in at least one variation, such known commercial and/or experimental measurement tolerances are +/−1% of the measured value.

The flowcharts and block diagrams in the figures illustrate the architecture, functionality, and operation of possible implementations of systems, methods, and computer program products according to various embodiments. In this regard, a block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a ROM, an EPROM or flash memory, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an ASIC, a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, radio frequency (RF), etc., or any suitable combination of the foregoing. Computer program code for carrying out operations for aspects of the present arrangements may be written in any combination of one or more programming languages, including an object-oriented programming language such as Java™, Smalltalk, C++, Python or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that a form or variation can or may comprise certain elements or features does not exclude other forms or variations of the present technology that do not contain those elements or features.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one variation, or various variations means that a particular feature, structure, or characteristic described in connection with a form or variation or particular system is included in at least one variation or form. The appearances of the phrase “in one variation” (or variations thereof) are not necessarily referring to the same variation or form. It should be also understood that the various method steps discussed herein do not have to be carried out in the same order as depicted, and not each method step is required in each variation or form.

The foregoing description of the forms and variations has been provided for purposes of illustration and description. It is not intended to be exhaustive or to limit the disclosure. Individual elements or features of a particular form or variation are generally not limited to that particular form or variation, but, where applicable, are interchangeable and can be used in a selected form or variation, even if not specifically shown or described. The same may also be varied in many ways. Such variations should not be regarded as a departure from the disclosure, and all such modifications are intended to be included within the scope of the disclosure.

What is claimed is:

1. A system comprising:
a processor; and
a memory communicably coupled to the processor and storing machine-readable instructions that, when executed by the processor, cause the processor to:
analyze a captured image of a film of a polymer dried per a first drying protocol and comprising a drying defect;
identify and classify the drying defect; and
predict, based at least in part on the first drying protocol and the classified defect, a second drying protocol different than the first drying protocol for drying another film of the polymer.

2. The system according to claim 1, wherein the machine-readable instructions stored in the memory, when executed by the processor, further cause the processor to predict a defect formation mechanism for the classified defect.

3. The system according to claim 2, wherein the machine-readable instructions stored in the memory, when executed by the processor, further cause the processor to predict the second drying protocol based at least in part on the defect formation mechanism.

4. The system according to claim 1, wherein the second drying protocol comprises a change to at least one of a solvent of the film, a solvent concentration of the film, a drying temperature, a drying time, and a gas flow rate.

5. The system according to claim 1, wherein the first drying protocol is based, at least in part on, at least one of a chemistry of the polymer of the film and at least one physical property of the polymer of the film.

6. The system according to claim 5, wherein the at least one physical property is one or more of a glass transition temperature of the polymer of the film, a Flory-Huggins parameter of the polymer of the film, a density of the polymer of the film, a molecular weight of the polymer of the film, a molar volume of the polymer of the film, a degree of polymerization of the polymer of the film, a crystallinity of the polymer of the film, and a specific gravity of the polymer of the film.

7. The system according to claim 1, wherein the machine-readable instructions stored in the memory, when executed by the processor, further cause the processor to predict the second drying protocol based, at least in part on, at least one of a chemistry of the polymer of the film, a chemical structure of the polymer of the film, and at least one physical property of the polymer of the film.

8. The system according to claim 7, wherein the at least one physical property is one or more of a glass transition temperature of the polymer of the film, a Flory-Huggins parameter of the polymer of the film, a density of the polymer of the film, a molecular weight of the polymer of the film, a molar volume of the polymer of the film, a degree of polymerization of the polymer of the film, a crystallinity of the polymer of the film, and a specific gravity of the polymer of the film.

9. The system according to claim 1, wherein the machine-readable instructions stored in the memory, when executed by the processor, further cause the processor to analyze a thickness profile of the dried film.

10. The system according to claim 9 wherein the machine-readable instructions stored in the memory, when executed by the processor, further cause the processor to predict the second drying protocol based, at least in part on, the analyzed thickness profile of the dried film.

11. The system according to claim 1 further comprising a robotic system, wherein the machine-readable instructions stored in the memory, when executed by the processor, further cause the processor to instruct the robotic system to form the film, dry the film per the first drying protocol, form the another film of the polymer, and dry the another film per the second drying protocol.

12. The system according to claim 11, wherein the machine-readable instructions stored in the memory, when executed by the processor, further cause the processor to:
instruct the robotic system to measure a thickness profile of the dried film; and
predict, based at least in part on the measured thickness profile, the second drying protocol.

13. The system according to claim 11, wherein the machine-readable instructions stored in the memory, when executed by the processor, further cause the processor to:
mix the polymer and a solvent from which the film is formed; and
mix the polymer and the solvent from which the another film is formed.

14. A system comprising:
a robotic system configured to form and dry a liquid layer on a surface;
a processor in communication with the robotic system; and
a memory communicably coupled to the processor and storing machine-readable instructions that, when executed by the processor, cause the processor to execute the following steps:
a) instruct the robotic system to form a film comprising a polymer and a solvent on the surface;
b) instruct the robotic system to dry the film per a first drying protocol and form a dried film;
c) capture and analyze an image of the dried film;
d) identify and classify, when present, a drying defect in the dried film;
e) predict, based at least in part on the classified defect, a defect formation mechanism for the classified defect;
f) predict, based at least in part on at least one of the classified defect and the defect formation mechanism, a second drying protocol for drying another film comprising the polymer; and
g) instruct the robotic system to form and dry the another film per the second drying protocol and form another dried film.

15. The system according to claim 14, wherein the second drying protocol comprises a change to at least one of the solvent of the film, a solvent concentration of the film, a drying temperature, a drying time, and a gas flow rate.

16. The system according to claim 14, wherein the memory communicably coupled to the processor further cause the processor to predict the first drying protocol in step b) based on, at least in part, at least one of a chemistry of the polymer and at least one physical property of the polymer.

17. The system according to claim 14, wherein the memory communicably coupled to the processor further cause the processor to:
instruct the robotic system to measure a thickness profile of the dried film; and
predict, based at least in part on the measured thickness profile, the second drying protocol in step f).

18. A method comprising:
analyzing an image of a film comprising a polymer dried per a first drying protocol and determining a defect in the dried film; and
predicting via machine learning a second drying protocol different than the first drying protocol.

19. The method according to claim 18, wherein the step of predicting via machine learning the second drying protocol comprises training a machine learning model using at least one of a chemistry of the polymer of the film, a chemistry of a solvent of the film, and a physical property of the polymer of the film as input.

20. The method according to claim 18, wherein the second drying protocol comprises a change to at least one of a solvent, a solvent concentration, a drying temperature, a drying time, and a gas flow rate.
